(19) United States
(12) Patent Application Publication
(10) Pub. No.: US 2005/0063084 A1
(43) Pub. Date: Mar. 24, 2005

(54) Apparatus controlling write current supplied to head and method for the apparatus

(75) Inventors: Seishiro Fujiwara, Ome-shi (JP); Naoki Kiuchi, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/932,329

(22) Filed: Sep. 2, 2004

(30) Foreign Application Priority Data
Sep. 2, 2003 (JP) 2003-310272

(51) Int. Cl. G11B 5/09; G11B 5/02

(52) U.S. Cl. 360/46; 360/61; 360/68

(57) ABSTRACT

A booster boosts a power voltage of a disk storage apparatus. The voltage obtained by boosting the power voltage is applied to a write driver in a head IC via a power line as a power voltage for the write driver. The power voltage of the disk storage apparatus is applied to a read amplifier in the head IC.

### CROSS-REFERENCE TO RELATED APPLICATIONS

This application is based upon and claims the benefit of priority from prior Japanese Patent Application No. 2003-310272, filed Sep. 2, 2003, the entire contents of which are incorporated herein by reference.

### BACKGROUND OF THE INVENTION

1. Field of the Invention

The present invention relates to a disk storage apparatus that uses a head to write data to and read it from a disk-shaped recording medium (that is, a disk medium), and in particular, to an apparatus controlling a write current supplied to the head, in accordance with write data, as well as a method for the apparatus.

2. Description of the Related Art

Hard disk drives are known to typify disk storage apparatuses using a disk (disk medium) as a storage medium. In recent years, more and more portable equipment in which a hard disk drive is mounted has been commercially available. Thus, a power voltage supplied to the hard disk drive is expected to shift from about 12 or 5V to a lower voltage of 3.3 or 1.8V (that is, the power voltage will be reduced). Further, in recent years, the recording density in the hard disk drive has been increasing. The recording density is expected to continuously increase in the future.

A write element in a head is used to write data to a disk. The write element is generally composed of an inductive thin-film element. A head IC (head amp circuit) varies the polarity of a write current flowing through a thin-film element on the basis of binary write data. By switching the direction of the current flowing through the thin-film element, at high speed, the recording density of binary data recorded on the disk is improved. However, the thin-film element has a coil structure, so that a higher frequency hinders the write current (effective current) from flowing smoothly through the thin-film element. A high power voltage is required to prevent this phenomenon to increase the recording density of the hard disk drive.

Jpn. Pat. Appln. KOKAI Publication No. 5-314411 describes a technique (prior art) to boost the power voltage of the hard disk drive and supply the boosted voltage to the head IC. With this prior art, even with a decrease in the power voltage of the hard disk drive, it is possible to prevent the malfunctioning of the drive to easily obtain good read/write characteristics. It is thus contemplated that this prior art may be applied to a reduction in the power voltage of the hard disk drive (disk storage apparatus) to reduce the power consumption of the drive.

However, with the above prior art, the boosted power voltages is supplied to and consumed in the head IC. This increases the power consumption. That is, in the prior art, there is a conflict between a reduction in the power consumption of the hard disk drive and an increase in recording density. Thus, an attempt to increase the recording density of the head disk drive may hinder a reduction in power consumption, which is expected to be achieved by reducing the power voltage of the hard disk drive.

### BRIEF SUMMARY OF THE INVENTION

According to an embodiment of the present invention, there is provided a disk storage apparatus which uses a head to read and write data from and to a disk. The head includes a thin-film element for writing. The thin-film element has first and second terminals to and from which a write current is input and output. The disk storage apparatus comprises a booster, a head IC, and a power line. The booster boosts the power voltage of the disk storage apparatus. The head IC includes a write driver and a read amplifier. The write driver is driven by the power voltage obtained by the boosting by the booster. The write driver supplies a write current to the thin-film element of the head in accordance with write data. The write current is supplied from one of the first and second terminals of the thin-film element to the other. The read amplifier is driven by the power voltage of the disk storage apparatus. The read amplifier amplifies a signal read by the head from the disk. The power line is used to supply the write driver with the power voltage obtained by the boosting by the booster as a power voltage for the write driver.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a hard disk drive (HDD) according to a first embodiment of the present invention;

FIG. 2 is a diagram showing the configuration of a circuit in a write driver 116b in FIG. 1;

FIG. 3 is a diagram showing the waveform of voltage applied to a coil and the waveform of current flowing through the coil;

FIG. 4 is a graph showing the relationship between write current and overwrite characteristic;

FIGS. 5A and 5B are diagrams showing the waveforms of control signals WD1 and WD2 supplied to the write driver 116b;

FIGS. 5C and 5D are diagrams showing the waveforms of potentials of terminals HY and HX of a thin-film element 112a included in a thin-film element 112a;

FIG. 6 is a diagram showing the waveform of voltage applied to the thin-film element 112a upon switching of polarity, in association with the waveform of write current flowing through the thin-film element 112a;

FIG. 7 is a graph showing the relationship between the write current and the overwrite characteristic at room temperature and at low temperature;

FIG. 8 is a block diagram showing the configuration of an HDD according to a second embodiment of the present invention; and

FIG. 9 is a block diagram showing the configuration of an HDD according to a third embodiment of the present invention.

### DETAILED DESCRIPTION OF THE INVENTION

[First Embodiment]

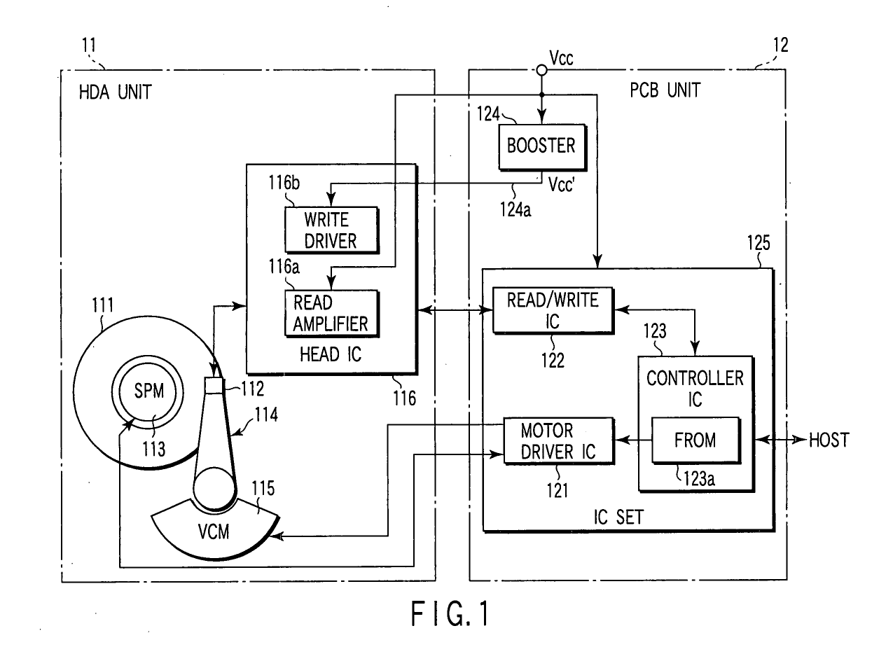

FIG. 1 is a block diagram showing the configuration of a hard disk drive according to a first embodiment of the present invention. The hard disk drive (HDD) in FIG. 1 is roughly composed of a head disk assembly unit (hereinafter referred to as an HDA unit) 11 and a printed circuit board unit (hereinafter referred to as a PCB unit) 12.

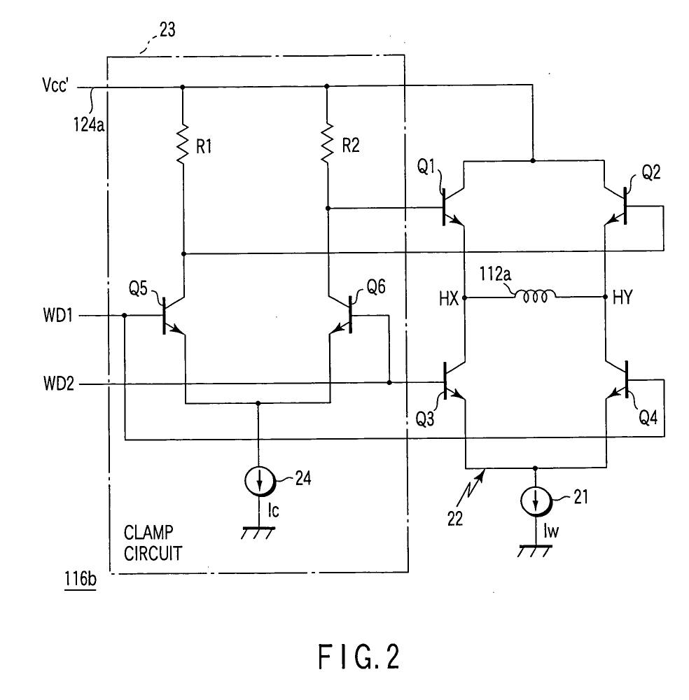

The HDA unit 11 includes a disk (magnetic disk) 111, a head (magnetic head) 112, a spindle motor (SPM) 113, an actuator 114, a voice coil motor (VCM) 115, and a head IC 116. The disk 111 has two disk surfaces, a top surface and a bottom surface. At least one of the two disk surfaces of the disk 111 constitutes a recording surface on which data is magnetically recorded. The head 112 is placed in association with one of the disk surfaces of the disk 111. The head 112 is a composite head composed of, for example, a magneto-resistive (MR) element (not shown) and an inductive thin-film element 112a (see FIG. 2). The MR element is used as a read element (read head). The inductive thin-film element 112a has a coil structure and is used as a write element (write head). For the convenience of drawing, FIG. 1 shows only the one head 112. However, in general, both disk surfaces of the disk 111 constitute recording surfaces, with two heads arranged in association with the respective disk surfaces. Further, FIG. 1 assumes the HDD comprising the single disk 111. However, the HDD may comprise a plurality of stacked disks 111.

The head 112 is used to read and write data from and to the disk 111. The SPM 113 rotates the disk 111 at high speed. The head 112 is attached to a leading end of the actuator 114. The actuator 114 is driven by a VCM 115 that is a driving source for the actuator 114. Thus, the actuator 114 moves the head 112 in a radial direction of the disk 111. The SPM 113 and the VCM 114 are driven by driving currents (SPM current and VCM current) supplied by a motor driver IC 121. The head 112 is connected to the head IC (head amp circuit) 116. The head IC 116 includes a read amplifier 116a and a write driver 116b. The read amplifier 116a amplifies a read signal read by the head 112.

The PCB unit 12 includes the following elements: a motor driver IC 121, a read/write IC (read/write channel) 122, a controller IC 123, and a booster 124. These elements are mounted on a PCB (not shown). The motor driver IC 121 supplies the SPM 113 with an amount of SPM current specified by the controller IC 123 to rotate the SPM 113 at a rated speed. The motor driver IC 121 also supplies the VCM 115 with an amount of VCM current specified by the controller IC 123 to position the head 112 at a target position on the disk 11. The read/write IC 122 is a signal processing device. The read/write IC 122 executes various signal processes including analog-to-digital conversion of a read signal, encoding of write data, and decoding of read data.

The controller IC 123 is a main controller of an HDD. The controller IC 123 controls the motor driver IC 121 and the other elements in the HDD except the motor driver IC 121 in a time division manner. The motor driver IC 121 is controlled in order to position the head 112 at the target position on the disk 111. The control provided by the controller IC 123 includes read/write control performed in accordance with a read command or a write command from a host. The host is electronic equipment utilizing the HDD in FIG. 1 and is typified by a personal computer. The controller IC 123 includes a storage device, for example, a flash ROM (FROM) 123a. The FROM 123a is a rewritable nonvolatile memory in which programs (control programs) to be executed by the controller IC 123 are stored.

The booster 124 boosts a power voltage Vcc (for the HDD) supplied by the host, to a power voltage Vcc′. The power voltage Vcc′ is supplied to the write driver 116b in the head IC 116 via a power line 124a. The power voltage Vcc′ is thus used as a power voltage for the write driver 116b. On the other hand, the power voltage Vcc is used for the circuit in the head IC 116 except for the write driver 116b. The circuit except for the write driver 116b includes the read amplifier 116a. That is, the power voltage Vcc is used for the read amplifier 116a. The power voltage Vcc is also used for the ICs included in a set 125 of ICs (hereinafter referred as an IC set 125) in the HDD other than the head IC 116. The IC set 125 includes the motor driver 121, the read/write IC 122, and the controller IC 123. That is, the power voltage Vcc is used for each of the motor driver IC 121, read/write IC 122, and controller IC 123.

In the HDD shown in FIG. 1, a magnetized layer is magnetized by a magnetic field generated when a write current is allowed to flow through the thin-film element 112a (see FIG. 2) of the head 112. Further, the direction of the magnetization is varied with the direction of the write current flowing through the thin-film element 112a. The magnetizing direction causes binary digitalized data to be recorded on the disk 111. Thus, the frequency of the write current flowing through the thin-film element 112a is very important as an element that determines the recording density of the HDD.

The write driver 116b in the head IC 116 supplies the write current flowing through the thin-film element 112a of the head 112. FIG. 2 shows the configuration of the write driver 116b. The write driver 116b includes a constant current source 21 and an H bridge circuit 22. The constant current source 21 generates a write current supplied to the thin-film element 112a. The write current generated by the constant current source 21 is limited to a constant current value Iw in a steady state. The value Iw can be varied in accordance with a specification provided by the controller IC 123. The write driver 116b uses the H bridge circuit 22 to switch the direction of a write current I flowing through the thin-film element 112a, in accordance with a control signal WD1 (first control signal) or a control signal WD2 (second control signal). The state of the signals WD1 and WD2 is determined by binary write data sent by the read/write IC 122 in FIG. 1. If one of the signals WD1 and WD2 is at high level (first state), the other is at a low level (second state). Both signals are not at high level at the same time. The write data is, for example, non-return to zero inverse (NRZI) data. The thin-film element 112a includes a pair of terminals HX and HY.

The H bridge circuit 22 includes a four bridged transistors Q1, Q2, Q3, and Q4. The transistors Q1, Q2, Q3, and Q4 are used as switching elements. The power voltage Vcc′ is applied to collectors of the transistors Q1 and Q2. The power voltage Vcc′ is supplied by the booster 124 via the power line 124a. An emitter of the transistor Q1 and a collector of the transistor Q3 are connected to the terminal HX (first terminal) of the thin-film element 112a. An emitter of the transistor Q2 and a collector of the transistor Q4 are connected to the terminal HY (second terminal) of the thin-film element 112a. The transistors Q1 and Q4 are controllably switched in accordance with the control signal WD1. On the other hand, the transistors Q2 and Q3 are controllably switched in accordance with the control signal WD2. The transistors Q1 and Q4 are turned on when the control signal WD1 is at high level. In this case, the write current I flows through the thin-film element 112a from terminal HX to terminal HY (first direction). On the other hand, the transistors Q2 and Q3 are turned on when the control signal WD2 is at the high level. In this case, the write current I flows through the thin-film element 112a from terminal HY to terminal HX (second direction). Here, the state of the control signals WD1 and WD2 is determined by the binary write data as described above. Specifically, the write driver 116b switches the direction (polarity) of the write current flowing through the thin-film element 112a on the basis of the binary write data. Since both control signals WD1 and WD2 are not at high level at the same time, the pair of transistors Q1 and Q4 and the pair of transistors Q2 and Q3 are not turned on at the same time.

The recording density of binary data recorded on the disk 111 is improved by switching the polarity of the write current flowing through the thin-film element 112a, at a higher switching speed. Thus, in the recent HDDs, the signals WD1 and WD2 are switched at a frequency of, for example, up to 300 MHz. The switching speed is expected to further increase in the future. However, the thin-film element 112a has a coil structure as described above. Thus, as the switching frequency increases at which the polarity of the write current flowing through the thin-film element 112 is switched, it becomes more and more difficult to cause the write current (effective current) to flow through the thin-film element 112.

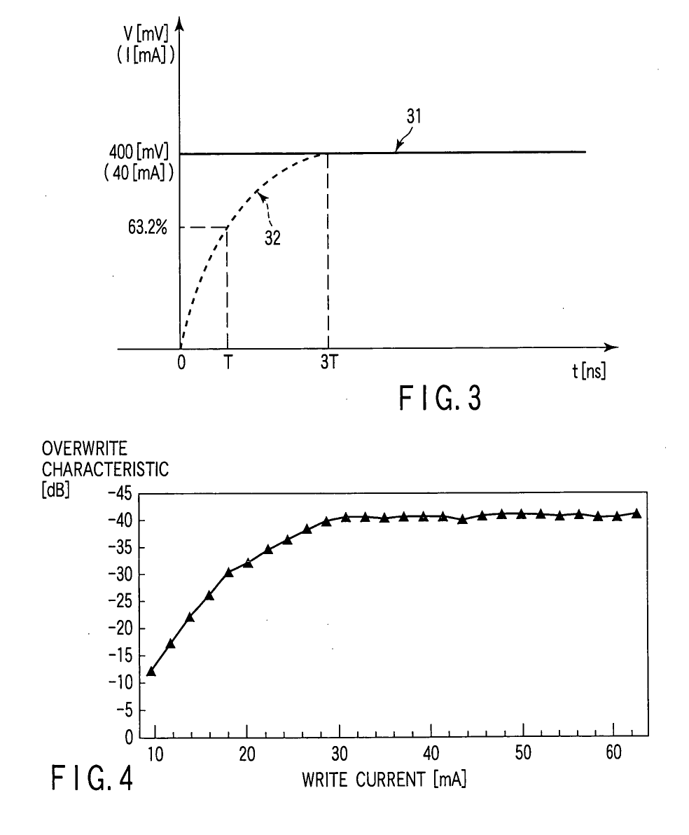

In general, the current I flowing through the coil during a transient response is expressed as follows:
I=(V/R)*(1−ε^{-(R/L)t}) (1)
where V denotes a voltage applied across the coil, R denotes the resistance of the coil, L denotes the inductance of the coil, and t denotes time. Equation (1) indicates that the inductance L and resistance R of the coil determine the transient response speed of the current I flowing through the coil. A simple example will be described below. It is assumed that a current of 40 mA is caused to flow through a coil with L=10 nH and R=10 Ω. In this case, since the resistance R of the coil is 10 Ω, a voltage of 400 mV may be applied across the coil. However, during the transient response, the current I flowing through the coil varies in accordance with Equation (1), as shown in FIG. 3. FIG. 3 shows the waveform 31 of a voltage V applied across the coil and the waveform 32 of the current I flowing through the coil. A value called a time constant T is used to express the time required before the current I reaches a desired current value during the transient response. This amount of time is equal to about triple the time constant T (3T). Here, for the above coil with L=10 nH and R=10 Ω, T=L/R=10[nH]/10[Ω]=1 ns. In this case, an amount of time equal to about 3T=3 ns is required before the current flowing through the coil reaches 40 mA. Such a characteristic of the current flowing through the coil during the transient response also applies to the write current flowing through the thin-film element 112a of the coil structure. However, with HDDs, for an increased recording density, it is necessary to switch the polarity of the write current flowing through the thin-film element of the coil structure, at a frequency of, for example, up to 300 MHz. Thus, the method of voltage application shown in FIG. 3 may switch the polarity of the write current before the desired write current value is reached. This may degrade the recording characteristics.

Now, description will be given of the relationship between the recording characteristic of the HDD and the write current. In general, data is written to the disk in the HDD by writing new data over previously written data. Thus, an overwrite characteristic is an important index of the recording characteristic of the HDD. The overwrite characteristic indicates the amount of that part of the original data to be overwritten which remains without being completely erased (that is, the amount of remaining components). To acquire the overwrite characteristic, first, a data signal is written to the disk at a certain frequency f1. The head is used to read the signal written in the disk. Then, the head outputs a read signal having a peak (V1) only at a frequency f1. Next, a data signal with a higher frequency f2 is written in an area of the disk in which the signal has already been written at the low frequency f1. The signal with the higher frequency f2 is read from the head. Then, the read signal output by the head includes not only a peak at the frequency f2 but also a peak at the frequency f1 (V2), which has a lower level. That is, even though the disk has been overwritten with the signal with the frequency f2, the original signal with the frequency f1 remains. The overwrite characteristic (OWM) is acquired in accordance with the equation shown below, using the ratio of the remaining component V2 to the peak V1.
OWM=20log₁₀(V2/V1)[dB] (2)
A larger value for the overwrite characteristic indicates a larger amount of remaining components of the previously written data. In this case, unexpected signal components may be contained in the read signal. Consequently, a larger value for the overwrite characteristic indicates the likelihood of erroneous data being read. That is, there is a strong correlation between the overwrite characteristic and a read failure rate.

FIG. 4 shows the relationship between the write current (I) flowing through the thin-film element 112a and the overwrite characteristic (OWM). As is apparent from FIG. 4, the overwrite characteristic varies significantly with the write current. The value for the overwrite characteristic increases with decreasing write current. This indicates that a smaller write current reduces the value for the overwrite characteristic to increase the read failure rate. Further, to ensure that the HDD has a sufficient overwrite characteristic, a certain write current is required. In the example in FIG. 4, a write current of about 30 to 40 mA is suitable in realizing the sufficient overwrite characteristic.

As previously described, when a voltage is applied to the thin-film element 112a with the coil structure using the method shown in FIG. 3, the recording characteristic may be degraded. Specifically, the method of voltage application shown in FIG. 3 makes it difficult to switch the frequency at a high frequency while allowing a write current of the desired value to flow through the thin-film element 112a. Thus, for the HDD in FIG. 1, to prevent the degradation of the recording characteristic, the write driver 116b in the head IC 116 applies a voltage to the thin-film element 112a using a new method (method of voltage application) different from the one shown in FIG. 3. The power voltage Vcc′, obtained by the booster 124 by boosting the voltage Vcc, is used for the write driver 116.

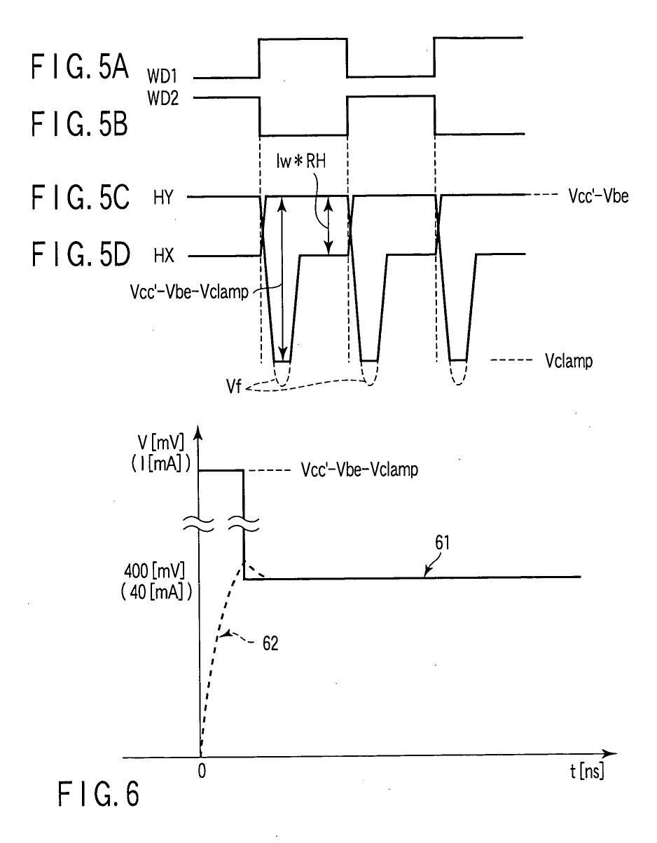

With reference to FIGS. 5A, 5B, 5C, and 5D, description will be given of operations of the write driver 116a, to which the new method of voltage application is applied. As previously described, the write current I flowing through the thin-film element 112a is controlled by the H bridge circuit 22, including the transistors Q1, Q2, Q3, and Q4. FIGS. 5A and 5B show the waveforms of the control signals WD1 and WD2, supplied to the write driver 116b. FIGS. 5C and 5D show the waveforms of potentials of the terminals HY and HX of the thin-film element 112a. When the control signal WD1 shifts from low level to high level, the control signal WD2 shifts from high level to low level. In this case, the terminal HY of the thin-film element 112a is switched from a flow-in end for the write current to a flow-out end for the write current. Then, a flyback voltage Vf attributed to the coil structure of the thin-film element 112a is generated at the terminal HY (write current flow-out end). Specifically, in the transient state in which the direction of the write current I is switched from HY→HX to HX→HY to switch the polarity, the flyback voltage Vf is generated at the terminal HY of the thin-film element 112a. Similarly, when the control signal WD2 shifts from low level to high level, the control signal WD1 shifts from high level to low level. In this case, the terminal HX of the thin-film element 112a is switched from the flow-in end for the write current to the flow-out end for the write current. Then, the flyback voltage Vf is generated at the terminal HX (write current flow-out end) of the thin-film element 112a. Specifically, in the transient state in which the direction of the write current I is switched from HX→HY to HY→HX to switch the polarity, the flyback voltage Vf is generated at the terminal HX of the thin-film element 112a. If the flyback voltage Vf is not restricted, the transistors Q1 to Q4 in the H bridge circuit 22 may be destroyed. Thus, the write driver 116b is provided with a clamp circuit 23 that restricts the flyback voltage Vf.

The clamp circuit 23 includes a pair of switching transistors Q5 and Q6. The control signals WD1 and WD2 are input to bases of the transistors Q5 and Q6, respectively. The bases of the transistors Q5 and Q6 are connected to bases of the transistors Q4 and Q3, respectively, in the H bridge circuit 22. The power voltage Vcc′ is applied to a collector of each of the transistors Q5 and Q6 via resistors R1 and R2, respectively. The power voltage Vcc′ is supplied by the booster 124 via the power line 124a. The resistors R1 and R2 have an equal resistance value. The resistance value of the resistors R1 and R2 is defined as Rc. The collectors of the transistors Q5 and Q6 are connected to the bases of the transistors Q2 and Q1, respectively, in the H bridge circuit 22. That is, the collectors of the transistors Q5 and Q6 provide potentials to the bases of the transistors Q2 and Q1, respectively.

When the control signals WD1 and WD2 shift to the high level, the transistors Q5 and Q6, respectively, are turned on. In this case, if one of the control signals WD1 and WD2 shifts to the high level, then the other shifts to the low level. That is, when one of the transistors Q5 and Q6 is turned on, the other is turned off. When the transistor Q5 or Q6 is turned on, the constant current source 24 allows a constant current Ic to flow through the collector of the transistor Q5 or Q6. At this time, the potential of the collector of the transistor Q5 or Q6 is Vcc′-I_{c}*R_{c}. The potential of the collector of the transistor Q5 or Q6 determines a clamp voltage V_{clamp}. The clamp circuit 23 provides the clamp voltage V_{clamp} by clamping (restricting) the flay back voltage Vf, generated at the terminal HY or HX of the thin-film element 112a. The values Ic and Rc are preselected to provide such potentials (low potentials) as prevents the collector potential of the turned-on transistor Q5 or Q6 from turning on the transistor Q2 or Q1 in the H bridge circuit 22.

In the transient state in which the polarity of the write current I is switched, operations of the above clamp circuit set the potentials of the terminals HX and HY of the thin film element 112a as described below. Here, as the switching of polarity of the write current I, it is assumed that the pair of the transistors Q1 and Q4 in the H bridge circuit 22 shifts from an OFF state to an ON state. First, the potential of the terminal HX of the thin-film terminal 112a is the difference (Vcc′-V_{be}) in potential between the power voltage Vcc′ and the voltage V_{be} between the base and emitter of the transistor Q2. On the other hand, the flyback voltage Vf is generated at the terminal HY of the thin-film element 112a owing to the coil structure of the thin-film terminal 112a. The value of the flyback voltage Vf depends on the power voltage (in this case, Vcc′) of the write driver 116b. However, the clamp circuit 23 restricts the flyback voltage Vf to the clamp voltage V_{clamp} as shown in FIG. 5D. Thus, the potential of the terminal HX of the thin-film element 112a is stable at V_{clamp}.

Consequently, when the polarity of the write current I is switched, the voltage between the terminals HX and HY of the thin-film element 112a is (Vcc′-V_{be}-V_{clamp}). On the other hand, in the steady state after the switching of the polarity, provided that the thin-film element 112a has a resistance value RH, the voltage between the terminals HX and HY is I*RH (I=Iw). In this case, (Vcc′-V_{be}-V_{clamp})>Iw*RH as shown in FIGS. 5C and 5D. Specifically, according to the present embodiment, upon the switching of the polarity, the flyback voltage Vf, generated at the terminal HY or HY of the thin-film terminal 112a, can be utilized to apply a voltage to between the terminals HX and HY of the thin-film terminal 112a, the voltage being higher than that obtained in the steady state. Further, since the clamp circuit 23 restricts the flyback voltage Vf to the clamp voltage V_{clamp}, a stably high voltage can be applied to between the terminals HX and HY. This enables an increase in the speed at which the write current I flowing through the thin-film element 112a rises.

FIG. 6 indicates a comparison of the method of voltage application according to the present embodiment with the method of voltage application shown in FIG. 3. FIG. 6 shows the waveform 61 of a voltage V applied to the thin-film element 112a upon the switching of the polarity (that is, during a transient response), in association with the waveform 62 of the write current I flowing through the thin-film element 112a. This figure indicates that the clamp circuit 23 in the write driver 116b sets the voltage applied to the thin-film element 112a at the stably high voltage (Vcc′-V_{be}-V_{clamp}) only during the transient response. This high voltage is determined mainly by the power voltage Vcc′ and the clamp voltage V_{clamp} (that is, the voltage restricting the flyback voltage Vf). The method of voltage application shown in FIG. 6 enables an increase in the speed at which a write current restricted by the time constant T (that is, the write current I flowing through the thin-film element 112a) rises. Thus, even with an increase in the frequency of data recorded in the disk 111, it is possible to obtain the desired write current I having a value that meets the overwrite characteristic, thus increasing the recording density of data.

In recent years, much effort has been directed to a reduction in the power consumption of HDDs and hosts utilizing the HDDs. Correspondingly, the power voltage supplied to the HDD is likely to shift from a voltage of about 12 or 5V to a lower voltage of 3.3 or 1.8V. With a reduced power voltage for the HDD, the method of voltage application shown in FIG. 3 contributes to reducing the rise speed of the write current I. This prevents an increase in the record frequency of data. However, in the present embodiment, the write driver 116b sets the voltage applied to the thin-film element 112a at the stably large value (Vcc′-V_{be}-V_{clamp}) only during the transient response. Further, the power voltage Vcc′, obtained by the booster 124 by boosting the voltage Vcc, is used for the write driver 116b; the power voltage Vcc′ is one of the elements determining this high voltage (Vcc′-V_{be}-V_{clamp}). Thus, the present embodiment makes it possible to increase the rise speed of the write current I and thus the recording frequency of data. Further, in the present embodiment, the power voltage Vcc′, obtained by the booster 124 by boosting the power voltage Vcc, is used only for the write driver 116b in the head IC 116, which requires a high voltage for the above described reason. The power voltage Vcc, supplied by the host, is directly used for the circuits in the head IC 116 except for the write driver 166b (that is, the circuits of the head IC, including a read amplifier 116a, excluding the write driver 166b) and for the Ics in the HDD except for the head IC 116 (that is, ICs in the IC set 125 including the motor driver IC 121, the read/write IC 122, and the controller IC 123). In this case, the output voltage Vcc′ from the booster 124 is used only when the HDD performs a write operation. Thus, the present embodiment limits the application range of the booster 124 in the HDD. This limitation minimizes an increase in power consumption, using the power voltage Vcc′, obtained by the booster 124 by boosting the power voltage Vcc. That is, the present embodiment makes it possible to provide an HDD with a high recording density without sacrificing power consumption.

[Second Embodiment]

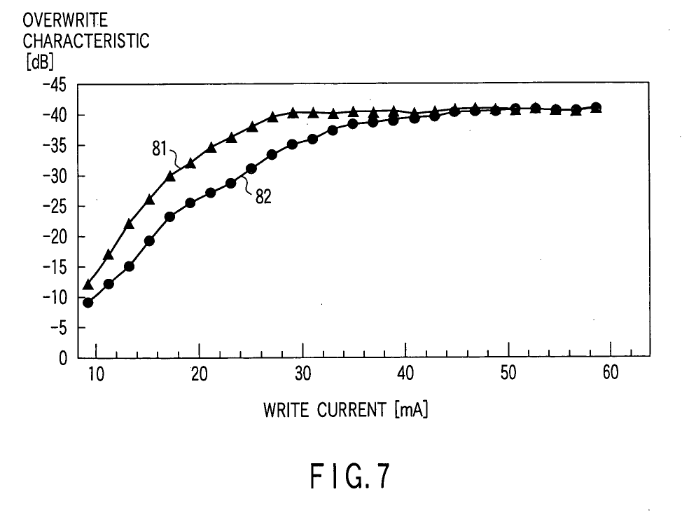

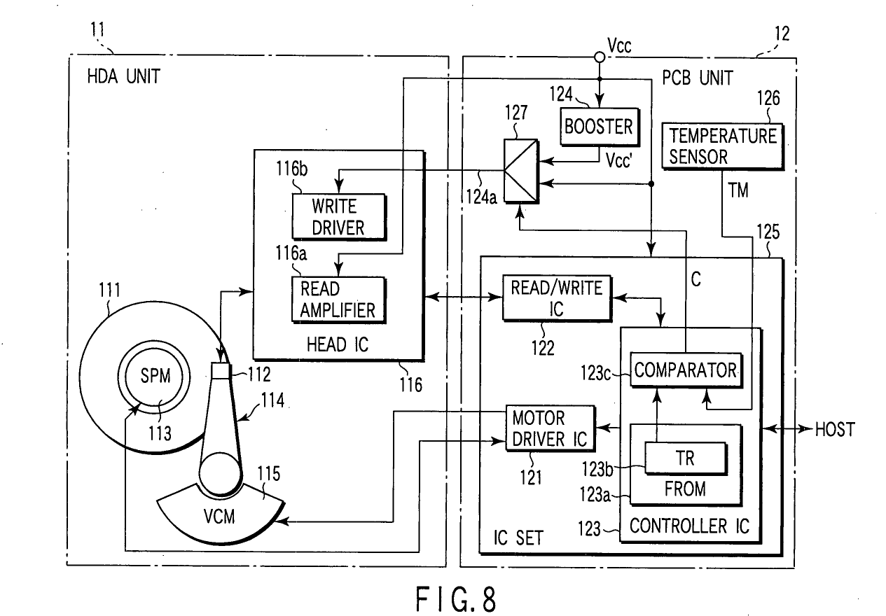

Now, a second embodiment of the present invention will be described. FIG. 7 shows the relationship between the write current (I) and overwrite characteristics (OWM) 81 and 82. The overwrite characteristic 81 relates to the write current at room temperature (25° C.). This figure indicates that the overwrite characteristic 81 is improved with increasing write current. The figure also indicates that the overwrite characteristic 81 is saturated at a certain write current value and is then no longer improved even with a further increase in the write current. In the example shown in FIG. 7, the overwrite characteristic is saturated with a write current of about 40 mA. On the other hand, the overwrite characteristic 82 relates to the write current at low temperature (0° C.). This figure indicates that a larger current is required to saturate the overwrite characteristic 82, compared to the overwrite characteristic 81 at room temperature. In the example shown in FIG. 7, a write current of about 50 mA is required to saturate the overwrite characteristic 82. The dependence of the overwrite characteristic on temperature is attributed to the temperature characteristic of the disk 111. The difference between the overwrite characteristics 81 and 82 shown in FIG. 7 means that at low temperature, a larger write current must be caused to flow through the thin-film element 112a in order to intensify a magnetic field generated from the thin-film element 112a. The intensified magnetic field is required in order to magnetize the magnetized layer of the disk 111.

Thus, the second embodiment uses a configuration that varies the write current flowing through the thin-film element 112a, depending on the temperature of the environment in which the HDD is used. That is, the second embodiment increases the write current so that the read failure rate of the HDD will not be affected by the degradation of the overwrite characteristic caused by a decrease in the environmental temperature of the HDD. The disk 111, used in the HDD in FIG. 1, is assumed to require a write current of 40 mA at room temperature and a write current of 50 mA at low temperature. Here, the transient response time of the write current is longest at low temperature. Thus, the booster 124 in the HDD in FIG. 1 needs to boost the power voltage Vcc to the value Vcc′, which is enough to provide the write current (50 mA), which is required at low temperature and has a sufficient transient response speed. In this case, the power voltage Vcc′, obtained by boosting the voltage Vcc and applied at low temperature, is applied to the write driver 116b in the HDD in FIG. 1 even at room temperature. However, the write current (40 mA) required at room temperature has a shorter transient response time than that required at low temperature. Thus, at room temperature, the write driver 116b can be adequately operated with a power voltage lower than the boosted voltage Vcc′, conforming to low temperature, for example, the power voltage Vcc, supplied by the host. This indicates that in the HDD in FIG. 1 (that is, the HDD according to the first embodiment), an excessive power voltage is applied to the write driver 116b at room temperature, thus consuming more power than required.

The second embodiment can further reduce the power consumption of the HDD compared to the first embodiment, utilizing the dependence of the overwrite characteristic on temperature. FIG. 8 shows the configuration of an HDD according to the second embodiment of the present invention. In FIG. 8, components similar to those in FIG. 1 are denoted by the same reference numerals. The HDD in FIG. 8 is characterized in that the power voltage applied to the write driver 116b is switched in accordance with the environmental temperature TM of the HDD. Thus, a temperature sensor 126 is provided in, for example, the PCB unit 12 in the HDD in FIG. 8 to measure the environmental temperature TM. Further, reference temperature information is prestored in a predetermined area 123b of the FROM 123a in the controller IC 123. The reference temperature information indicates a reference temperature TR used to determine the above low temperature. Furthermore, a comparator 123c is provided in the controller IC 123. The comparator 123c compares a temperature TM measured by the temperature sensor 126 with the reference temperature TR. The comparator 123c outputs a control signal C in accordance with the result of comparison of the temperature. Additionally, 2-input 1-output voltage selector 127 is provided in, for example, the PCB unit 12. The voltage selector 127 selects either the power voltage Vcc or Vcc′ for the write driver 116b in accordance with the control signal C. The output of the voltage selector 127 is connected to the power line 124a.

In the HDD in FIG. 8, for example, at fixed time intervals, the comparator 123c compares the temperature TM measured by the temperature sensor 126 with the reference temperature TR, indicated by the reference temperature information stored in the area 123b of the FROM 123a. If TM<TR, the comparator 123c outputs the control signal C at high level, which indicates that the environment in which the HDD is used is at low temperature. On the other hand, if TM≧TR, the comparator 123c outputs the control signal C at low level, which indicates that the environment in which the HDD is used is at room temperature. The control signal C is supplied to the voltage selector 127.

In the description below, it is assumed that since TM<TR (that is, the environment in which the HDD is used is at low temperature), the comparator 123c outputs the control signal C at high level to the voltage selector 127. While the control signal C is at high level, the voltage selector 127 selects the power voltage Vcc′ (obtained by the booster 124 by boosting the power voltage Vcc) instead of the power voltage Vcc. The power voltage Vcc′, selected by the voltage selector 127, is applied to the write driver 116b via the power line 124a as a power voltage for the write driver 116b, included in the head IC 116.

Thus, in the second embodiment of the present invention, at room temperature, at which the write driver 116b does not require a high voltage to operate (non-low-temperature state), the power voltage Vcc, supplied by the host, is applied to the driver 116b. This makes it possible to prevent the write driver 116b from wastefully consuming power at room temperature. Further, in the second embodiment, at low temperature, at which the write driver 116b requires a high voltage to operate, the power voltage Vcc′, obtained by the booster 124 by boosting the power voltage Vcc, is applied to the driver 116b. Thus, it is possible to allow a write current which is larger than the one required at room temperature and which has a sufficient transient response speed to flow through the thin-film element 112a. That is, the second embodiment accomplishes stable magnetic recording while suppressing an increase in power consumption more thoroughly than in the first embodiment.

The reference temperature TR, used to determine whether the environment in which the HDD is used is at low temperature or at room temperature, varies depending on the structure and material characteristics of the disk 111, used in the HDD. Thus, the second embodiment uses a configuration in which information indicating the reference temperature TR unique to the disk 111, used in the HDD, is stored in the FROM 123a, included in the controller IC 123. Consequently, even if the state of the disk 111, used in the HDD, is changed, it is possible to deal easily with the change in the disk 111 by rewriting the reference temperature information stored in the FROM 123a.

[Third Embodiment]

Now, a third embodiment of the present invention will be described. As previously described, the transient response speed of the write current varies depending on the value of the write current. Further, for the HDD, the write current is preferably varied depending on the environmental temperature. At low temperature, the write current needs to be large. Then, in the third embodiment, the value of the write current, determined from the environmental temperature measured by the temperature sensor 126, is used to switch the power voltage applied to the write driver 116b. In this point, the third embodiment is different from the second embodiment, which uses the result of temperature measurement made by the temperature sensor 126 to switch the power voltage.

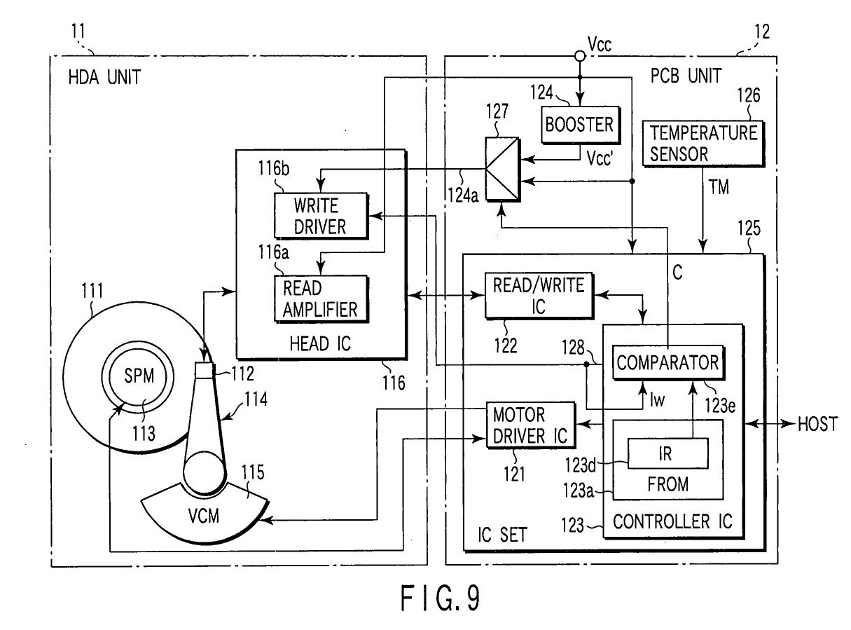

FIG. 9 is a block diagram showing the configuration of an HDD according to the third embodiment of the present invention. Components of the third embodiment similar to those in FIG. 8 are denoted by the same reference numerals. In the HDD in FIG. 9, the controller IC 123 has a function to determine the write current Iw in the steady state in accordance with the temperature TM, measured by the temperature sensor 126. The controller IC 123 also has a control function to cause the write driver 116b to allow a write current of the determined value to flow through the thin-film element 112a. To control the write current, the controller IC 123 uses a write current specification signal 128 to specify the determined write current (Iw) for the write driver 116b. The reference current information indicating the reference current value IR is prestored in the predetermined area 123d of the FROM 123a in the controller IC 123. If the environmental temperature of the HDD is equal to the reference temperature TR, applied in the second embodiment, a write current specified by the controller ID 123 is used as the reference current IR. A comparator 123e is provided in the controller IC 123. The comparator 123e compares the write current value IW specified by the write current specification signal 128, with the reference current IR. If Iw>IR, the comparator 123e outputs the control signal C at high level, which indicates that the environment in which the HDD is used is at low temperature. On the other hand, If Iw≦IR, the comparator 123e outputs the control signal C at low level, which indicates that the environment in which the HDD is used is at room temperature. The control signal C is supplied to the voltage selector 127. The subsequent operations are similar to those in the second embodiment. That is, if Iw>IR, the voltage selector 127 selects the power voltage Vcc′, obtained by the booster 124 by boosting the power voltage Vcc, in accordance with the control signal C at high level. The power voltage Vcc′ is then applied to the write driver 116b. On the other hand, if Iw≦IR, the voltage selector 127 selects the power voltage Vcc, supplied by the host, in accordance with the control signal C at low level. The power voltage Vcc is then applied to the write driver 116b. Thus, the third embodiment produces effects similar to those of the second embodiment. While the controller IC 123 does not output the effective write current specification signal 128, the comparator 123e outputs the control signal C at low level as in the case Iw≦IR.

In the above first to third embodiment, the hard disk drive (HDD) is used as a disk storage device. However, the present invention is applicable to any disk storage apparatuses such as magneto-optical disk drives in which a head including a thin-film element for writing reads and writes data from and to a disk.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A disk storage apparatus which uses a head to read and write data from and to a disk, the head including a thin-film element for writing, the thin-film element having first and second terminals to and from which a write current is input and output, the disk storage apparatus comprising:
a booster which boosts the power voltage of the disk storage apparatus;
a head IC including a write driver and a read amplifier, the write driver being driven by the power voltage obtained by the boosting by the booster to supply a write current to the thin-film element of the head in accordance with write data, the write current being supplied from one of the first and second terminals of the thin-film element to the other, the read amplifier being driven by the power voltage of the disk storage apparatus to amplify a signal read by the head from the disk; and
a power line which is used to supply the write driver with the power voltage obtained by the boosting by the booster as a power voltage for the write driver.

2. The disk storage apparatus according to claim 1, wherein only the write driver in the head IC is driven by the power voltage supplied via the power line.

3. The disk storage apparatus according to claim 1, further comprising:
a temperature sensor which measures an environmental temperature of the disk storage device; and
a selector which selects one of the power voltage of the disk storage apparatus and the power voltage obtained by the boosting by the booster as a power voltage for the write driver in accordance with a result of the temperature measurement made by the temperature sensor, the selector including an output terminal connected to the power line.

4. The disk storage apparatus according to claim 3, further comprising:
a storage device which stores reference temperature information indicative of a reference temperature; and
a comparator which compares the result of the temperature measurement made by the temperature sensor, with reference temperature information stored in the storage device,
and wherein the selector selects the power voltage obtained by the boosting by the booster if a result of the comparison made by the comparator indicates that the temperature measured by the temperature sensor is lower than the reference temperature, and otherwise selects the power voltage of the disk storage device.

5. The disk storage apparatus according to claim 1, further comprising:
a temperature sensor which measures an environmental temperature of the disk storage device;
means for specifying a value of the write current supplied by the write driver to the thin-film element of the head, in accordance with a result of the temperature measurement made by the temperature sensor; and
a selector which selects one of the power voltage of the disk storage apparatus and the power voltage obtained by the boosting by the booster as a power voltage for the write driver in accordance with the write current value specified by the specifying means, the selector including an output terminal connected to the power line.

6. The disk storage apparatus according to claim 5, further comprising:
a storage device which stores a reference write current value; and
a comparator which compares the write current value specified by the specifying means, with a reference write current value stored in the storage device,
and wherein the selector selects the power voltage obtained by the boosting by the booster if a result of the comparison made by the comparator indicates that the write current value specified by the specifying means is larger than the reference write current value, and otherwise selects the power voltage of the disk storage device.

7. The disk storage apparatus according to claim 1, further comprising:
a temperature sensor which measures an environmental temperature of the disk storage device;
a main controller configured to specify a value of the write current supplied by the write driver to the thin-film element of the head, in accordance with a result of the temperature measurement made by the temperature sensor; and
a selector which selects one of the power voltage of the disk storage apparatus and the power voltage obtained by the boosting by the booster as a power voltage for the write driver in accordance with the write current value specified by the main controller, the selector including an output terminal connected to the power line.

8. The disk storage apparatus according to claim 7, further comprising:
a storage device which stores a reference write current value; and
a comparator which compares the write current value specified by the main controller, with a reference write current value stored in the storage device,
and wherein the selector selects the power voltage obtained by the boosting by the booster if a result of the comparison made by the comparator indicates that the write current value specified by the main controller is larger than the reference write current value, and otherwise selects the power voltage of the disk storage device.

9. The disk storage apparatus according to claim 1, wherein the write driver includes:
a bridge circuit including a pair of first and second transistors and a pair of third and fourth transistors, the pair of the first and second transistors being configured to be turned on in response to a transition of a first control signal to a first state corresponding to the write data to supply the write current in a first direction from the first terminal toward the second terminal, the pair of the third and fourth transistors being configured to be turned on in response to a transition of a second control signal to the first state corresponding to the write data to supply the write current in a second direction from the second terminal toward the first terminal;
a current source which generates the write current; and
a clamp circuit configured to clamp, at a fixed voltage, a first flyback voltage generated at the first terminal of the thin-film element and a second flyback voltage generated at the second terminal of the thin-film element, the first flyback voltage being generated when the direction of the write current is switched to the first direction in response to the transition of the first control signal to the first state, the second flyback voltage being generated when the direction of the write current is switched to the second direction in response to the transition of the second control signal to the first state.

10. The disk storage apparatus according to claim 9, wherein the clamp circuit includes:
a fifth transistor which clamps the first flyback voltage at the fixed voltage and which is turned on in response to the transition of the first control signal to the first state; and
a sixth transistor which clamps the second flyback voltage at the fixed voltage and which is turned on in response to the transition of the second control signal to the first state.

11. A method of controlling a write current supplied to a thin-film element for writing included in a head, the head being used to read and write data from and to a disk in a disk storage apparatus, the thin-film element having first and second terminals to and from which the write current is input and output, the method comprising:
boosting the power voltage of the disk storage apparatus, using a booster; and
applying the power voltage obtained by the boosting by the booster only to a write driver in a head IC including the write driver and a read amplifier, the write driver being driven by the applied power voltage to supply a write current to the thin-film element of the head in accordance with write data, the write current being supplied from one of the first and second terminals of the thin-film element to the other, the read amplifier amplifying a signal read by the head from the disk.

12. The method according to claim 11, further comprising measuring an environmental temperature of the disk storage apparatus, using a temperature sensor, and wherein the applying includes applying the power voltage of the disk storage apparatus to the write driver if the environmental temperature measured by the temperature sensor is higher than a preset reference temperature.

13. The method according to claim 11, further comprising clamping a flay back voltage generated in the thin-film element, and wherein the flyback voltage is generated at one of the first and second terminals of the thin-film element from which the write current flows out during a transient response at which the direction of the write current supplied to the thin-film element is switched.
